(19) United States
(12) Patent Application Publication
(10) Pub. No.: US 2026/0125049 A1
(43) Pub. Date: May 7, 2026

(54) PARKING ASSIST APPARATUS, PARKING ASSIST METHOD, AND VEHICLE

(71) Applicant: Panasonic Automotive Systems Co., Ltd., Kanagawa (JP)

(72) Inventor: Takeo TOMIDA, Kanagawa (JP)

(73) Assignee: Panasonic Automotive Systems Co., Ltd., Kanagawa (JP)

(21) Appl. No.: 19/375,819

(22) Filed: Oct. 31, 2025

(30) Foreign Application Priority Data
Nov. 5, 2024 (JP) 2024-193658

(51) Int. Cl. B60W 30/06

(52) U.S. Cl. CPC B60W 30/06; B60W 2554/802

(57) ABSTRACT

A parking assist apparatus includes: determination circuitry, which, in operation, acquires information on a distance to a peripheral object from a sensor configured to be mounted on a vehicle by a time of flight (TOF) method during traveling of the vehicle in automatic parking, and determines whether an obstacle is present in a space facing a side of the vehicle based on the information, the information being referred to as distance information; and detection circuitry, which, in operation, detects a parking frame for the automatic parking in the space based on a determination result of the determination circuitry.

### TECHNICAL FIELD

The present disclosure relates to a parking assist apparatus, a parking assist method, and a vehicle.

### BACKGROUND ART

A parking assist apparatus that assists automatic parking of a vehicle in a parking space is known. For example, the related art discloses an apparatus that configures a guide path according to whether an obstacle is a curb or a wall when performing automatic parallel parking. In such related art, an ultrasonic wave is transmitted from a sensor such as a sonar, a reflected wave reflected by an obstacle is received, and a parking frame for automatic parking is detected by using coordinate information of the obstacle generated based on the principle of triangulation.

### CITATION LIST

### Patent Literature

PTL 1

JP 6625228

### SUMMARY OF INVENTION

### Technical Problem

### Solution to Problem

A parking assist apparatus according to the present disclosure includes: determination circuitry, which, in operation, acquires information on a distance to a peripheral object from a sensor configured to be mounted on a vehicle by a time of flight (TOF) method during traveling of the vehicle in automatic parking, and determines whether an obstacle is present in a space facing a side of the vehicle based on the information, the information being referred to as distance information; and detection circuitry, which, in operation, detects a parking frame for the automatic parking in the space based on a determination result of the determination circuitry.

A parking assist method according to the present disclosure includes: acquiring information on a distance to a peripheral object from a sensor configured to be mounted on a vehicle by a time of flight (TOF) method during traveling of the vehicle in automatic parking, the information being referred to as distance information; making a determination of whether an obstacle is present in a space facing a side of the vehicle based on the distance information; and detecting a parking frame for the automatic parking in the space based on a result of the determination.

A vehicle according to the present disclosure includes: the parking assist apparatus described above.

### Advantageous Effects of Invention

According to the present disclosure, a parking frame for automatic parking can be accurately detected.

### BRIEF DESCRIPTION OF DRAWINGS

FIG. 1 is a block diagram illustrating a configuration example of a vehicle to which a parking assist apparatus according to the present embodiment is applied;

FIG. 2A is a diagram for describing detection of a parking frame for perpendicular parking;

FIG. 2B is another diagram for describing detection of a parking frame for perpendicular parking;

FIG. 3A is a diagram for describing detection of a parking frame for parallel parking in the related art;

FIG. 3B is another diagram for describing detection of a parking frame for parallel parking in the related art;

FIG. 4A is a diagram for describing detection of a parking frame for parallel parking in the present embodiment;

FIG. 4B is another diagram for describing detection of a parking frame for parallel parking in the present embodiment;

FIG. 4C is still another diagram for describing detection of a parking frame for parallel parking in the present embodiment;

FIG. 5 is a flowchart describing an operation example of parking frame detection control in the parking assist apparatus;

FIG. 6 is a flowchart describing an operation example of coordinate generation processing in the parking assist apparatus;

FIG. 7 is a flowchart describing an operation example of detection processing of a parking frame for perpendicular parking in the parking assist apparatus;

FIG. 8 is a flowchart describing an operation example of detection processing of a parking frame for parallel parking in the parking assist apparatus; and

FIG. 9 is a block diagram illustrating a configuration example of a vehicle to which a parking assist apparatus according to a variation is applied.

### DESCRIPTION OF EMBODIMENTS

### Embodiment

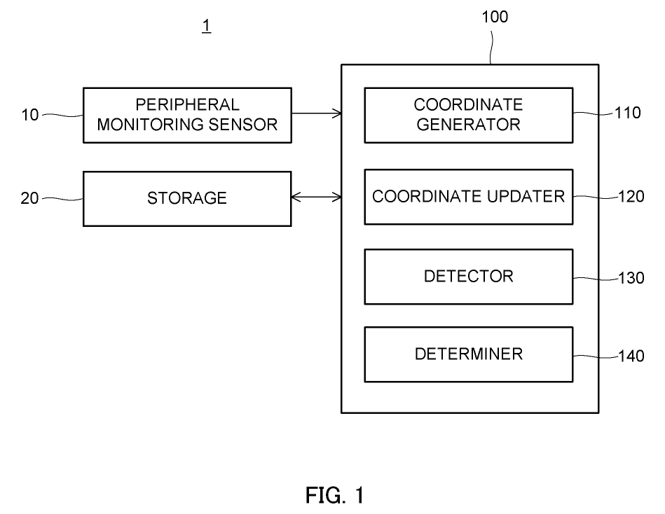

Hereinafter, an embodiment of the present disclosure will be described in detail with reference to the drawings. FIG. 1 is a block diagram illustrating a configuration example of vehicle 1 to which parking assist apparatus 100 according to the present embodiment is applied.

As illustrated in FIG. 1, vehicle 1 has an automatic parking assist function for automatically parking in a parking space, and includes peripheral monitoring sensor 10, storage 20, and parking assist apparatus 100.

Peripheral monitoring sensor 10 is, for example, an in-vehicle sensor such as a sonar or a radar, and is a sensor for monitoring a peripheral object of vehicle 1. A plurality of peripheral monitoring sensors 10 are provided, for example, on the side of vehicle 1, and can detect a peripheral object (obstacle) facing the side of vehicle 1.

Specifically, peripheral monitoring sensor 10 is provided with a sensor for transmission and a sensor for reception. A detection wave transmitted from the sensor for transmission is reflected by an obstacle and received by the sensor for reception. The distance between vehicle 1 and the obstacle can be calculated by a time-of-flight (TOF) method based on a round-trip time of the detection wave. In addition, by calculating the distance, coordinates of a position where the detection wave is reflected by the obstacle can be calculated by a principle of triangulation.

Storage 20 is, for example, a volatile memory and can store information detected by peripheral monitoring sensor 10 or the like. In addition, storage 20 stores, for example, information on coordinates calculated based on the information detected by peripheral monitoring sensor 10.

Parking assist apparatus 100 includes a central processing unit (CPU), a read only memory (ROM), a random access memory (RAM), and input/output circuity, which are not illustrated, and performs automatic parking control for automatic parking in a parking space. Specifically, parking assist apparatus 100 detects a parking frame based on the detection information of peripheral monitoring sensor 10 during traveling of vehicle 1 in the automatic parking, and controls vehicle 1 to automatically park in the parking frame.

Parking assist apparatus 100 includes coordinate generator 110, coordinate updater 120, detector 130, and determiner 140.

Coordinate generator 110 calculates distance information between vehicle 1 and an obstacle based on a round-trip time of a detection wave detected by peripheral monitoring sensor 10, and generates coordinate information of the obstacle based on the distance information.

The coordinate information is, for example, information of an XY coordinate system. The X coordinate is a position coordinate in a traveling direction (hereinafter, also referred to as an X direction) of vehicle 1 in the automatic parking. The Y coordinate is a position coordinate in a direction orthogonal to the traveling direction and a direction perpendicular to the side of vehicle 1 (hereinafter, also referred to as a Y direction).

For example, coordinate generator 110 generates the coordinate information of the obstacle by using a principle of triangulation. Coordinate generator 110 stores the generated coordinate information in storage 20.

Coordinate updater 120 updates the coordinate information stored in storage 20. Storage 20 stores the coordinate information sufficient for detecting a parking frame, and coordinate updater 120 updates the oldest coordinate information with newly generated coordinate information as vehicle 1 travels.

Detector 130 detects the parking frame for the automatic parking based on the coordinate information generated by coordinate generator 110.

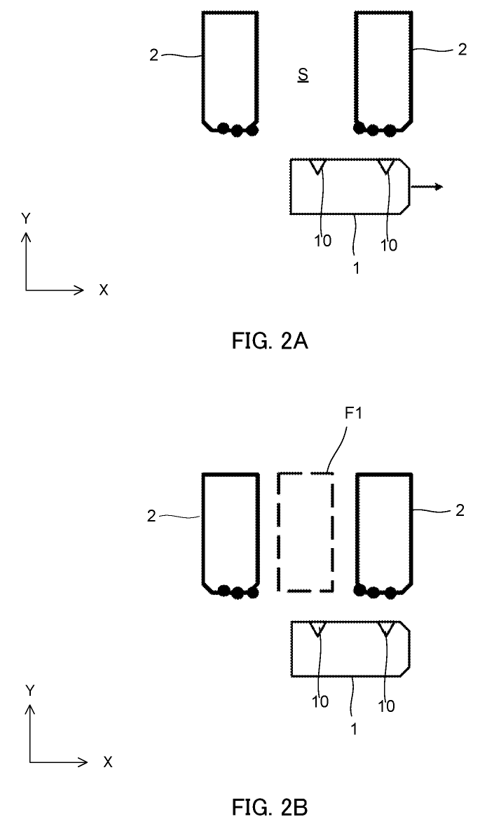

For example, as illustrated in FIGS. 2A and 2B, it is assumed to park vehicle 1 in space S between a plurality of other vehicles 2 by perpendicular parking in the automatic parking. The perpendicular parking is parking, for example, in a case where vehicle 1 is parked so as to be along a direction (Y direction) orthogonal to the traveling direction (X direction) of vehicle 1 in the automatic parking.

In this case, coordinate generator 110 generates the coordinate information of other vehicles 2. Since there is no obstacle in space S between two other vehicles 2, the coordinate information corresponding to the space is not generated. In FIG. 2A, black circles indicate portions where the detection waves of peripheral monitoring sensor 10 are reflected toward vehicle 1 (see FIG. 2A).

In a case where the gap between two other vehicles 2 based on the coordinate information is within a range where the perpendicular parking is possible, detector 130 detects parking frame F1 for the perpendicular parking (see FIG. 2B). Then, parking assist apparatus 100 starts the automatic parking toward parking frame F1. Note that a known technology is used as a method of the automatic parking, such as a method of generating a route, after parking frame F1 is detected.

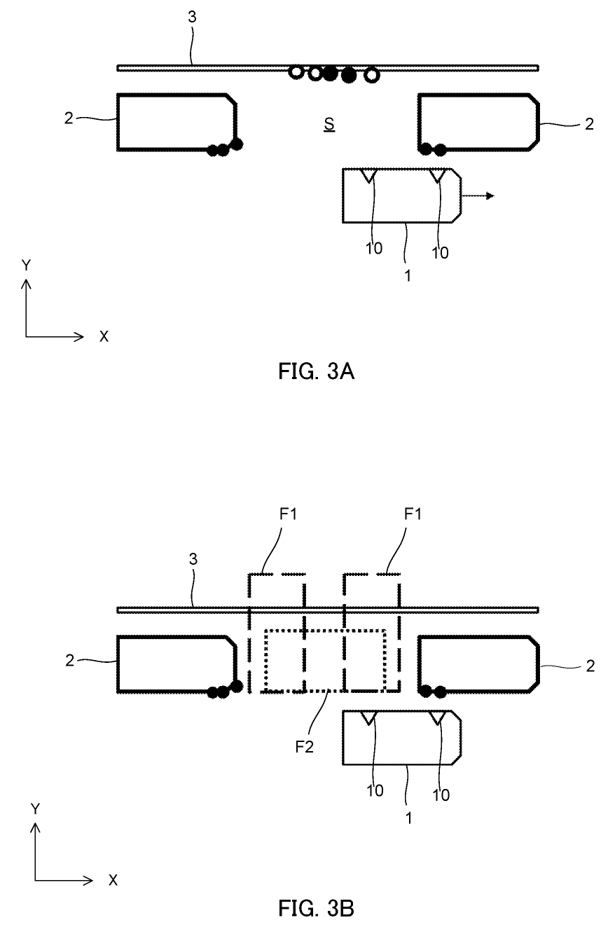

For example, as illustrated in FIGS. 3A and 3B, it is assumed to park vehicle 1 in space S between a plurality of other vehicles 2 by parallel parking in the automatic parking. The parallel parking is parking, for example, in a case where vehicle 1 is parked so as to be along the traveling direction (X direction) of vehicle 1 in the automatic parking. FIG. 3A illustrates a case where obstacle 3 is present in parallel with other vehicles 2 that are parallel parked. Obstacle 3 is an obstacle located farther than the other vehicles in space S, and is a curb, a wall, or a step portion, for example.

In the case of the parallel parking, obstacle 3 is present farther than other vehicles 2 that are already parked. Therefore, it is desirable to accurately detect obstacle 3 in order to detect parking frame F2 for the parallel parking.

However, in a case where obstacle 3 is an object having a low height or weak reflectivity, such as a curb or a step portion, the coordinate information of obstacle 3 may not be accurately generated. Specifically, in such a case, the detection of the round-trip time of the detection wave by peripheral monitoring sensor 10 is unstable, so that coordinate generator 110 may not accurately generate the coordinates of obstacle 3 by the principle of triangulation.

For example, even in the case where the detection of the round-trip time of the detection wave is unstable, the distance to obstacle 3 can be relatively accurately detected. However, in the triangulation for detecting the coordinates of a reflection point based on a triangle formed by the paths before and after the reflection of the detection wave, when the detection of the round-trip time of the detection wave is unstable, a great error is caused in calculating the coordinates of the reflection point at obstacle 3 in the rear area. Specifically, the coordinates cannot be detected at a large number of portions of obstacle 3, resulting in a long interval between the portions where the coordinates can be detected (the portions where the coordinates are generated). The generated coordinates are required to be dense considering the reliability of the coordinates, so that the long interval between the portions where the coordinates can be detected is not preferable from the viewpoint of reliability.

In the examples illustrated in FIGS. 3A and 3B, the black circles indicate portions where the coordinates are accurately detected, and the white circles indicate portions where the coordinates are not accurately detected.

When the coordinates of obstacle 3 are not accurately generated, it is difficult to accurately detect parking frame F2 by detector 130. Specifically, when there are no coordinates in the Y direction, detector 130 is likely to detect parking frame F1 for perpendicular parking instead of the parallel parking; accordingly, it may be difficult to accurately detect the parking frame for the automatic parking (see FIG. 3B).

In the present embodiment, determiner 140 determines whether obstacle 3 is present to overcome the difficulty in detecting the parking frame as in the case of the parallel parking. Specifically, determiner 140 determines whether obstacle 3 is present in the rear area of the space on the side of vehicle 1 based on the distance information (distance information in the Y direction) between vehicle 1 and the obstacles (including the plurality of other vehicles 2 and obstacle 3) facing the side of vehicle 1, which is obtained by the TOF method, during the traveling of vehicle 1 in the automatic parking.

More specifically, determiner 140 acquires the distance information between an obstacle and vehicle 1 each time vehicle 1 travels a predetermined distance, and determines that obstacle 3 is present when the distance between the obstacle and vehicle 1 at each position is within a predetermined range.

For example, the predetermined distance is a distance of each portion obtained by equally dividing the distance (distance in the X direction) corresponding to a parking space into a plurality of portions, and can be set to an appropriate distance such as 50 mm.

The predetermined range is a range corresponding to the width (distance in the Y direction) of the parking space for the parallel parking, and can be set to an appropriate range such as 4 to 5 m.

The distance being within the predetermined range means that all of the distances between the obstacle and vehicle 1 at respective positions, which are acquired each time vehicle 1 travels the predetermined distance, are within the predetermined range. In addition, the distance being within the predetermined range may include a case where some information is not acquired as the distance information or some distance information is of the distance exceeding the predetermined range, among all the distances based on the acquired distance information. The information that is not acquired as the distance information is, for example, information of a portion of obstacle 3 along the parking space where no object is present, such as a portion between curbs. In addition, the distance exceeding the predetermined range is, for example, a distance obtained when an object located further back than the obstacle is detected as the distance information.

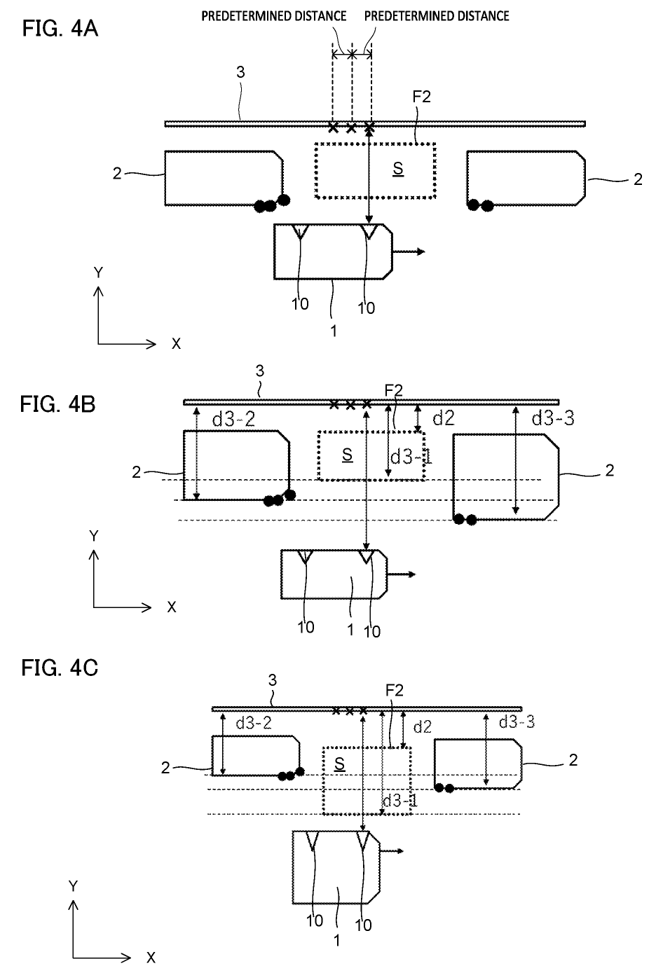

When one or more distances based on the distance information are within the predetermined range while vehicle 1 travels the predetermined distance, determiner 140 acquires the distance information, and determiner 140 acquires the distance information each time vehicle 1 travels the predetermined distance. For example, in FIG. 4A, when vehicle 1 passes through space S between two other vehicles 2, determiner 140 acquires the distance information between vehicle 1 and the portions of obstacle 3 indicated by X each time vehicle 1 travels the predetermined distance. The portions indicated by X are portions of obstacle 3 that face the side of vehicle 1 and reflect the detection waves of peripheral monitoring sensor 10.

When a difference between a maximum value and a minimum value of the distances based on all of the distance information acquired each time vehicle 1 travels the predetermined distance is within a predetermined threshold, which can be set to any value, determiner 140 determines that the obstacle is obstacle 3.

Detector 130 detects a parking frame based on the determination result of determiner 140. Specifically, in a case where determiner 140 determines that obstacle 3 is present, detector 130 detects a parking frame for parallel parking.

The parking frame for parallel parking in this case may be detected by using coordinate information generated based on the distance information acquired by the TOF method, for example. In this case, coordinate generator 110 generates simple coordinate information by using position information in the Y direction based on the distance information and position information in the X direction when the distance information is acquired for each predetermined distance. Specifically, coordinate generator 110 generates the coordinate information of obstacle 3 by using the position of vehicle 1 when vehicle 1 travels the predetermined distance and the distance information acquired at the position. Then, detector 130 detects parking frame F2 by using the simple coordinate information (first coordinate information).

This operation makes it easier to accurately obtain the information on obstacle 3 when performing parallel parking, thereby accurately detecting a parking frame for automatic parking.

In addition, since coordinate generator 110 generates the coordinate information (second coordinate information) based on the principle of triangulation in addition to the first coordinate information described above, determiner 140 does not determine whether obstacle 3 is present based on the distance information in a case where all the second coordinate information is generated. Meanwhile, determiner 140 determines whether obstacle 3 is present based on the distance information in a case where at least some of the coordinate information based on the principle of triangulation is not generated.

Since the coordinate information based on the principle of triangulation has higher accuracy than the simple coordinate information based on the distance information described above, determiner 140 determines whether obstacle 3 is present based on the distance information in a case where at least some of the coordinate information based on the principle of triangulation is not generated. As a result, a parking frame for automatic parking can be more accurately detected.

Note that, in the description of FIG. 4A, it is assumed that the sizes (the vehicle widths and the total lengths) of two other vehicles 2 and the size (the vehicle width and the total length) of vehicle 1 are substantially the same, but in FIG. 4B, a case where the sizes of two other vehicles 2 are larger than the size of vehicle 1 is described, and in FIG. 4C, a case where the sizes of two other vehicles 2 are smaller than the size of vehicle 1 is described.

In FIG. 4B, the vehicle width of vehicle 1 is smaller than the vehicle widths of two other vehicles 2, and vehicle 1 is to be parked at a position predetermined distance d2 away from obstacle 3. Therefore, distances d3-1, d3-2, and d3-3 from obstacle 3 to the farther sides of the respective vehicles are different from each other. Note that predetermined distance d2 is a distance in consideration of the opening and closing of the door of vehicle 1 and obstacle 3, and changes depending on the size of vehicle 1.

In FIG. 4C, the vehicle width of vehicle 1 is larger than the vehicle widths of two other vehicles 2, and vehicle 1 is to be parked at a position predetermined distance d2 away from obstacle 3. Therefore, distances d3-1, d3-2, and d3-3 from obstacle 3 to the farther sides of the respective vehicles are different from each other.

In a case where triangulation is used for the detection of obstacle 3 as in the related art, the detection of obstacle 3 may be insufficient due to two other vehicles 2. Therefore, when vehicle 1 is parked according to distances d3-2 and d3-3, it is difficult to ensure predetermined distance d2, and this potentially causes difficulty in opening and closing the door.

However, as in the present disclosure, when triangulation is used for the detection of two other vehicles 2 and the TOF is used for the detection of obstacle 3, the detection of obstacle 3 can be sufficiently performed even when two other vehicles 2 are present. Even in a case where the vehicle widths of two other vehicles 2 are different from each other, vehicle 1 is parked in parallel based on predetermined distance d2 from obstacle 3, and this makes it easy to open and close the door of vehicle 1.

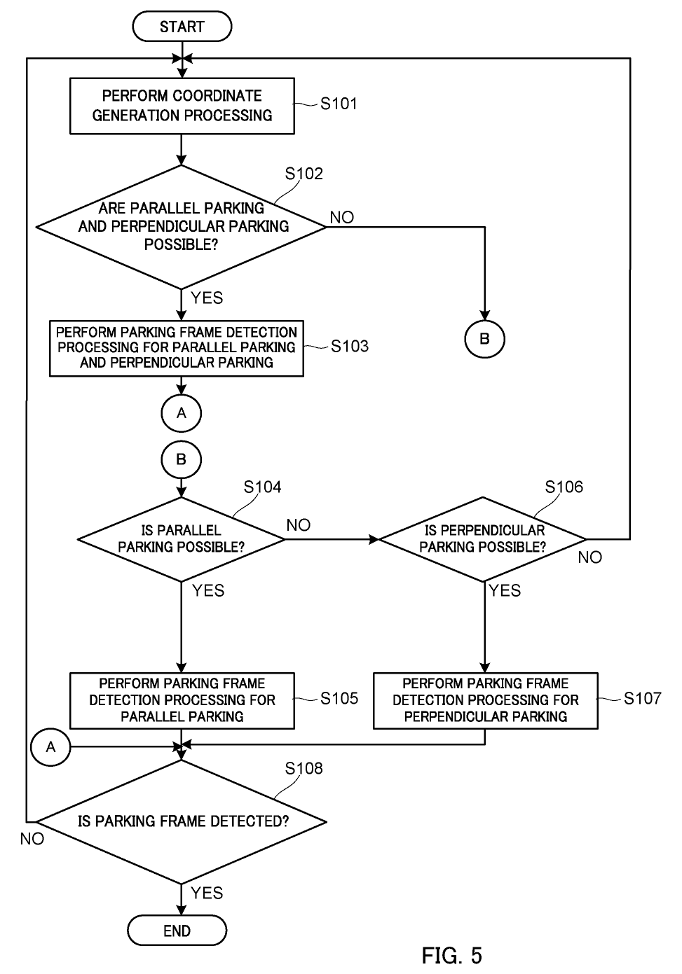

Next, an operation example of parking assist apparatus 100 of the present disclosure will be described. FIG. 5 is a flowchart describing an operation example of the parking frame detection control in parking assist apparatus 100. This control is appropriately performed, for example, when automatic parking is started by user’s operation.

As described in FIG. 5, parking assist apparatus 100 performs coordinate generation processing (step S101). Details of the coordinate generation processing will be described later. After step S101, parking assist apparatus 100 determines whether parallel parking and perpendicular parking are possible (step S102). Note that whether parallel parking and perpendicular parking are possible is determined based on information of the width of a parking space, information on the presence or absence of obstacle 3 in the rear area, and the like.

In a case where parallel parking and perpendicular parking are not possible as a result of the determination (NO in step S102), parking assist apparatus 100 determines whether parallel parking is possible (step S104). Meanwhile, in a case where parallel parking and perpendicular parking are possible (YES in step S102), parking assist apparatus 100 performs detection processing of parking frames for the parallel parking and the perpendicular parking (step S103). Details of each detection processing will be described later.

In addition, in a case where parallel parking is not possible as a result of the determination (NO in step S104), parking assist apparatus 100 determines whether perpendicular parking is possible (step S106). Meanwhile, in a case where parallel parking is possible (YES in step S104), parking assist apparatus 100 performs detection processing of a parking frame for the parallel parking (step S105). Details of each detection processing will be described later.

Further, in a case where perpendicular parking is not possible as a result of the determination (NO in step S106), the processing returns to step S101. Meanwhile, in a case where perpendicular parking is possible (YES in step S106), parking assist apparatus 100 performs detection processing of a parking frame for the perpendicular parking (step S107). Details of each detection processing will be described later. Note that, in FIG. 5, the determination of whether parallel parking is possible is performed before the determination of whether perpendicular parking is possible, but the determination of whether parallel parking is possible may be performed after the determination of whether perpendicular parking is possible.

After step S103, step S105, or step S107, parking assist apparatus 100 determines whether a parking frame is detected (step S108). In a case where a parking frame is not detected as a result of the determination (NO in step S108), the processing returns to step S101. Meanwhile, in a case where a parking frame is detected (YES in step S108), the present control ends.

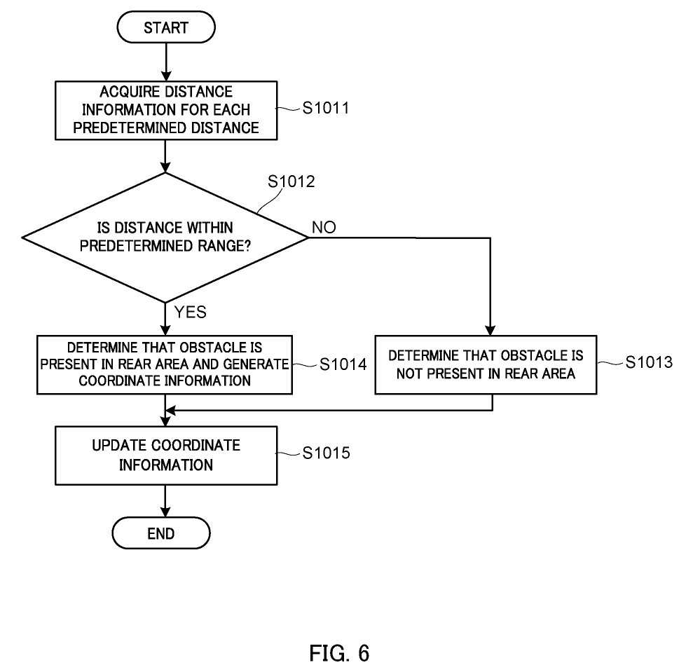

Next, an operation example of the coordinate generation processing in step S101 of FIG. 5 will be described. FIG. 6 is a flowchart describing an operation example of the coordinate generation processing in parking assist apparatus 100.

Note that this coordinate generation processing is generation processing of the first coordinate information described above based on the distance information acquired by determiner 140 (based on the TOF method). While the generation processing is performed, generation processing of the second coordinate information is also performed using the distance information corresponding to the principle of triangulation among all the distance information. The distance information corresponding to the principle of triangulation is, for example, distance information obtained from a reflection wave transmitted by a first sensor and received by a second sensor in a case where a plurality of sensors are used, and is distance information using a reflection wave transmitted by a sensor and received by the sensor after a vehicle is moved in a case where one sensor is used. Since a known technology can be applied to the generation processing of the second coordinate information based on the principle of triangulation, the description thereof will be omitted.

As described in FIG. 6, parking assist apparatus 100 acquires information on the distance between an obstacle and vehicle 1 at each position for each predetermined distance (step S1011). After step S1011, parking assist apparatus 100 determines whether the distance acquired in step S1011 is within a predetermined range (step S1012).

In a case where the distance is not within the predetermined range as a result of the determination (NO in step S1012), parking assist apparatus 100 determines that obstacle 3 is not present (step S1013). Meanwhile, in a case where the distance is within the predetermined range (YES in step S1012), parking assist apparatus 100 determines that obstacle 3 is present, and generates the coordinate information (step S1014).

After step S1013 or step S1014, parking assist apparatus 100 updates the coordinate information (step S1015). Note that, in step S1015, the coordinate information generated in the generation processing of the coordinate information based on the principle of triangulation is also updated in addition to the coordinate information generated in step S1014.

After step S1015, the present control ends, and the processing transitions to step S102 of FIG. 5.

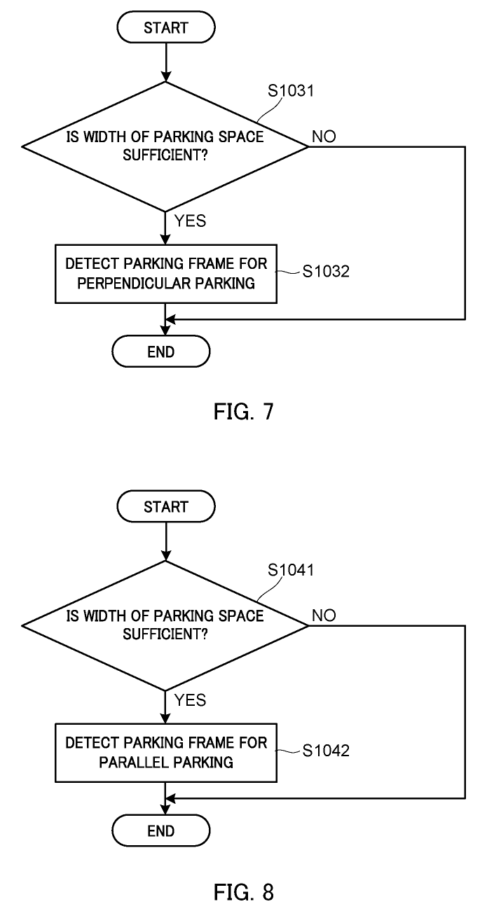

Next, an operation example of the detection processing of a parking frame for perpendicular parking will be described. FIG. 7 is a flowchart describing an operation example of the detection processing of a parking frame for perpendicular parking in parking assist apparatus 100.

As described in FIG. 7, parking assist apparatus 100 determines whether the width of a parking space is sufficient for perpendicular parking (step S1031). In a case where the width of the parking space is not sufficient as a result of the determination (NO in step S1031), the present control ends.

Meanwhile, in a case where the width of the parking space is sufficient (YES in step S1031), parking assist apparatus 100 detects a parking frame for perpendicular parking (step S1032). After step S1032, the present control ends. Note that, after the present control ends, the processing transitions to step S105 of FIG. 5.

Next, an operation example of the detection processing of a parking frame for parallel parking will be described. FIG. 8 is a flowchart describing an operation example of the detection processing of a parking frame for parallel parking in parking assist apparatus 100.

As described in FIG. 8, parking assist apparatus 100 determines whether the width of a parking space is sufficient for parallel parking (step S1041). In a case where the width of the parking space is not sufficient as a result of the determination (NO in step S1041), the present control ends.

Meanwhile, in a case where the width of the parking space is sufficient (YES in step S1041), parking assist apparatus 100 detects a parking frame for parallel parking (step S1042). After step S1042, the present control ends. Note that, after the present control ends, the processing transitions to step S105 of FIG. 5.

According to the present embodiment configured as described above, the presence or absence of obstacle 3 is determined based on the distance information from peripheral monitoring sensor 10, and a parking frame for automatic parking is detected based on the determination result. Specifically, determiner 140 determines that obstacle 3 is present in a case where the distance between the obstacle and vehicle 1 at each position remains within a predetermined range each time vehicle 1 travels a predetermined distance.

This facilitates the determination of the presence or absence of obstacle 3, so that it is possible to easily determine the presence of obstacle 3 even in a case of obstacle 3 whose coordinate information is difficult to be generated based on the principle of triangulation, for example. As a result, a parking frame for automatic parking can be accurately detected.

In addition, since the coordinate information of obstacle 3 is generated by using a position of vehicle 1 when vehicle 1 travels a predetermined distance and the distance information acquired at the position, the coordinate information of obstacle 3 can be generated by a simple method.

Note that, in the embodiment described above, either a parking frame for parallel parking or a parking frame for perpendicular parking is detected, but the present disclosure is not limited to this, and both a parking frame for parallel parking and a parking frame for perpendicular parking may be detectable.

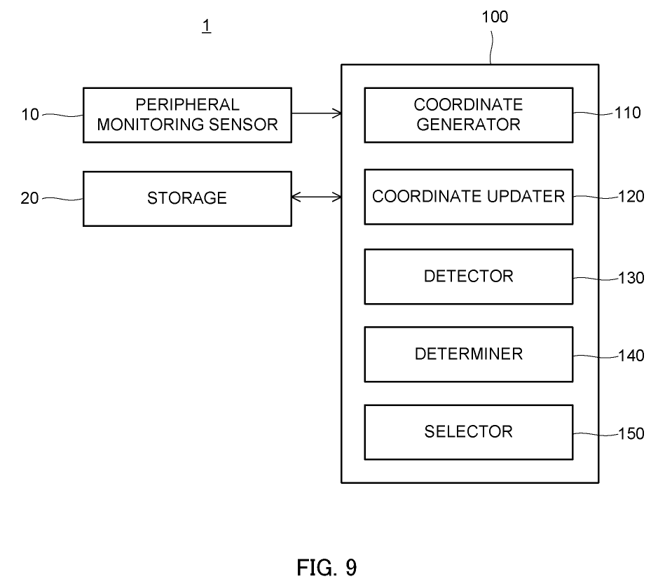

In this case, as illustrated in FIG. 9, parking assist apparatus 100 may further include selector 150 that selects either a parking frame for parallel parking or a parking frame for perpendicular parking.

Selector 150 may present both a parking frame for parallel parking and a parking frame for perpendicular parking to a user and select either one of the two parking frames according to the user’s operation of selecting either one of the two parking frames.

Alternatively, selector 150 may select either the parking frame for perpendicular parking or the parking frame for parallel parking based on information of a past parking history.

As described above, an additional function of selecting parallel parking or perpendicular parking enables flexible automatic parking.

In addition, in the embodiment described above, a parking frame for perpendicular parking is not detected when obstacle 3 is determined to be present, but the present disclosure is not limited to this. For example, a parking frame for perpendicular parking may be detected in a case where there is a sufficient space for perpendicular parking even with the presence of obstacle 3, such as a case where the distance to obstacle 3 based on the distance information exceeds a predetermined range.

In addition, the embodiment described above is merely an example of specific embodiments for carrying out the present disclosure, and the technical scope of the present disclosure is not limited thereto. Therefore, the present disclosure can be carried out in various forms without departing from the gist or main features of the present disclosure.

While various embodiments have been described herein above, it is to be appreciated that various changes in form and detail may be made without departing from the spirit and scope of the invention(s) presently or hereafter claimed.

This application is entitled and claims the benefit of Japanese Patent Application No2024-193658, filed on November 5, 2024, the disclosure of which including the specification, drawings and abstract is incorporated herein by reference in its entirety.

### Industrial Applicability

The parking assist apparatus according to the present disclosure is useful as a parking assist apparatus, a parking assist method, and a vehicle each capable of accurately detecting a parking frame for automatic parking.

1. A parking assist apparatus comprising:
determination circuitry, which, in operation, acquires information on a distance to a peripheral object from a sensor configured to be mounted on a vehicle by a time of flight (TOF) method during traveling of the vehicle in automatic parking, and determines whether an obstacle is present in a space facing a side of the vehicle based on the information, the information being referred to as distance information; and
detection circuitry, which, in operation, detects a parking frame for the automatic parking in the space based on a determination result of the determination circuitry.

2. The parking assist apparatus according to claim 1, wherein the determination circuitry determines that the obstacle is present in a case where the distance information acquired each time the vehicle travels a predetermined distance is within a predetermined range.

3. The parking assist apparatus according to claim 1, further comprising:
coordinate generation circuitry, which, in operation, generates coordinate information of the obstacle by using a predetermined distance that the vehicle has traveled and first distance information corresponding to the predetermined distance among all pieces of the distance information, wherein,
the detection circuitry detects the parking frame in the space based on the coordinate information.

4. The parking assist apparatus according to claim 3, wherein,
the coordinate generation circuitry generates first coordinate information by using the predetermined distance that the vehicle has traveled and the first distance information corresponding to the predetermined distance among the all pieces of distance information, and generates second coordinate information by using second distance information corresponding to a principle of triangulation among the all pieces of distance information, and
the determination circuitry determines whether the obstacle is present by using the first coordinate information in a case where at least some of the second coordinate information is not generated.

5. The parking assist apparatus according to claim 2, wherein,
the detection circuitry:
detects a parking frame for perpendicular parking in a case where it is determined that the obstacle is not present within the predetermined range; and
detects a parking frame for parallel parking in a case where it is determined that the obstacle is present within the predetermined range.

6. The parking assist apparatus according to claim 1, further comprising selection circuitry, which, in operation, selects at least one of a parking frame for perpendicular parking and/or a parking frame for parallel parking in a case where both the parking frame for perpendicular parking and the parking frame for parallel parking are detected by the detection circuitry.

7. A parking assist method comprising:
acquiring information on a distance to a peripheral object from a sensor configured to be mounted on a vehicle by a time of flight (TOF) method during traveling of the vehicle in automatic parking, the information being referred to as distance information;
making a determination of whether an obstacle is present in a space facing a side of the vehicle based on the distance information; and
detecting a parking frame for the automatic parking in the space based on a result of the determination.

8. The parking assist method according to claim 7, further comprising:
determining that the obstacle is present in a case where the distance information acquired each time the vehicle travels a predetermined distance is within a predetermined range.

9. The parking assist method according to claim 8, further comprising:
generating coordinate information of the obstacle by using the predetermined distance that the vehicle has traveled and first distance information corresponding to the predetermined distance among all pieces of the distance information, wherein,
the parking frame is detected in the space based on the coordinate information.

10. The parking assist method according to claim 8, further comprising:
generating first coordinate information by using the predetermined distance that the vehicle has traveled and first distance information corresponding to the predetermined distance among all pieces of the distance information, and generating second coordinate information by using second distance information corresponding to a principle of triangulation among the all pieces of distance information, wherein,
in the determining, whether the obstacle is present is determined by using the first coordinate information in a case where at least some of the second coordinate information is not generated.

11. The parking assist method according to claim 8, further comprising:
detecting a parking frame for perpendicular parking in a case where it is determined that the obstacle is not present within the predetermined range; and
detecting a parking frame for parallel parking in a case where it is determined that the obstacle is present within the predetermined range.

12. The parking assist method according to claim 11, further comprising:
selecting at least one of the parking frame for perpendicular parking and/or the parking frame for parallel parking in a case where both the parking frame for perpendicular parking and the parking frame for parallel parking are detected.

13. A vehicle comprising the parking assist apparatus according to claim 1.
